(19) United States
(12) Patent Application Publication
(10) Pub. No.: US 2015/0026566 A1
(43) Pub. Date: Jan. 22, 2015

(54) SYSTEMS AND METHODS TO PRIORITIZE BROWSER TILE GENERATION FROM LQ TILE CONTENT

(71) Applicant: QUALCOMM Incorporated, San Diego, CA (US)

(72) Inventors: Shiu Wai Hui, Richmond Hill, CA (US); Veluppillai Arulesan, Toronto (CA)

(21) Appl. No.: 13/943,274

(22) Filed: Jul. 16, 2013

(51) Int. Cl. G06F 17/22

(52) U.S. Cl. CPC G06F 17/2247
USPC 715/240

(57) ABSTRACT

Systems and methods are disclosed for web browsers to prioritize rendering of low quality (LQ) tiles of webpages into high quality (HQ) tiles based on an estimated amount of information content in the LQ tiles. While HQ tiles are tiles that have been rendered previously, LQ tiles are scaled down versions of the information content overlapped by the LQ tiles. LQ tiles provide quick thumbnail sketches of the information content but need to be rendered into HQ tiles to fully display the information. Web browsers may display a frame of a webpage as a mixture of LQ and HQ tiles. The amount of information of the webpage content contained in the LQ tiles may be estimated using information metrics. The importance of the LQ tiles is ranked based on the information metrics. LQ tiles that have more information, and hence deemed as more important, are rendered into HQ tiles first.

### TECHNICAL FIELD

This application generally relates to displaying multimedia content on display devices. In particular, this application relates to methods and systems to accelerate rendering webpages containing multimedia content on display screens.

### BACKGROUND

Webpages are full of rich multimedia contents that may include graphics, videos, images, text, etc. To allow smooth scrolling of webpages in web browsers, webpages may be divided into tiles. Tiles whose contents have been rendered may be cached to accelerate the rendering of the webpages during scrolling. A browser window displaying frames of a webpage may retrieve cached tiles and copy the cached tiled to the appropriate offsets within the browser window as the webpage is scrolled across the screen. When a portion of the webpage is not yet cached in tiles, but is to be rendered on the screen, the browser window may draw a blank area. To minimize degradation in display quality, the browser may attempt to minimize the portions of the webpage displayed as blank area on the screen.

Conventionally, browsers may render low quality (LQ) tiles of the webpage to replace the blank area overlapping the LQ tiles. The LQ tiles are relatively fast to render compared to fully rendered tiles, referred to as high quality (HQ) tiles, and may be used for quickly conveying a thumbnail sketch of the webpage content overlapped by the LQ tiles. To further accelerate the rendering of webpages, the LQ tiles may be similarly cached as the HQ tiles. However, the information conveyed by LQ tiles is often limited because the LQ tiles inherently look blurry. Accordingly, to fully display the webpage content, the browser may render HQ tiles to replace the LQ tiles on the screen. However, during fast scrolling, the browser may not have enough time to render all the LQ tiles to HQ tiles. Therefore, the browser window may not display important content of the webpage, thus limiting the overall user experience. As such, there is a need for a solution to enable web browsers to quickly render frames of webpages with minimal degradation in display quality or information content during fast scrolling of the webpages.

### SUMMARY

Systems and methods are disclosed for web browsers to prioritize rendering of LQ tiles of webpages into HQ tiles based on an estimated amount of information content in the LQ tiles during fast scrolling of webpages. LQ tiles with higher estimated information content are rendered into HQ tiles first. As web browsers display a frame of a webpage, certain portions of the webpage frame may be cached and rendered as HQ tiles and other portions as LQ tiles. The amount of information of the webpage content contained in the LQ tiles is estimated using information metrics. The importance of the LQ tiles is ranked based on the information metrics. LQ tiles that have more information, and hence deemed as more important, are rendered into HQ tiles first. Advantageously, by rendering LQ tiles with more information into HQ tiles first, users may pay more attention to these tiles and may not notice the absence of information from LQ tiles containing less information. Thus, users may fast scroll webpages with minimal degradation in the display quality or information content of the webpages.

A method for displaying data on a display device is disclosed. The method includes dividing the data into a number of tiles. The method also includes determining a portion of the data that will be displayed in a data frame. The method further includes rendering the data in the data frame as one or more tiles on the display device. The data overlapped by a tile is fully rendered as a HQ tile if HQ rendering of the data overlapped by the tile is available. Otherwise, the data overlapped by a tile is partially rendered as a LQ tile. The method further includes obtaining information metrics for each LQ tile of the data frame, where the information metrics quantify information content of the data overlapped by the LQ tile. The method further includes ranking the LQ tiles of the data frame based on the information metrics to determine a priority for rendering the LQ tiles into HQ tiles. The method further includes rendering the LQ tiles of the data frame into HQ tiles on the display device in accordance with the priority.

An apparatus to display data is disclosed. The apparatus includes a display. The apparatus includes a memory, and one or more processors that read the memory. The processors are configured to divide data for display into a number of tiles. The processors are also configured to determine a portion of the data that will be displayed in a data frame. The processors are further configured to render the data in the data frame as one or more tiles on the display. The data overlapped by a tile is fully rendered as a HQ tile if HQ rendering of the data overlapped by the tile is available. Otherwise, the data overlapped by a tile is partially rendered as a LQ tile. The processors are further configured to obtain information metrics for each LQ tile of the data frame, where the information metrics quantify information content of the data overlapped by the LQ tile. The processors are further configured to rank the LQ tiles of the data frame based on the information metrics to determine a priority to render the LQ tiles into HQ tiles. The processors are further configured to render the LQ tiles of the data frame into HQ tiles on the display in accordance with the priority.

A non-transitory computer-readable medium that stores machine-readable instructions for execution by processors are disclosed. The processors read the instructions to perform steps for displaying data on a display device. The instructions include steps to divide the data for display into a number of tiles. The instructions further include steps to determine a portion of the data that will be displayed in a data frame. The instructions further include steps to render the data in the data frame as one or more tiles on the display device. The data overlapped by a tile is fully rendered as a HQ tile if HQ rendering of the data overlapped by the tile is available. Otherwise, the data overlapped by a tile is partially rendered as a LQ tile. The instructions further include steps to obtain information metrics for each LQ tile of the data frame, where the information metrics quantify information content of the data overlapped by the LQ tile. The instructions further include steps to rank the LQ tiles of the data frame based on the information metrics to determine a priority to render the LQ tiles into HQ tiles. The instructions further include steps to render the LQ tiles of the data frame into HQ tiles on the display device in accordance with the priority.

A system for displaying data on a display device is disclosed. The system includes means for dividing the data into a number of tiles. The system also includes means for determining a portion of the data that will be displayed in a data frame. The system further includes means for rendering the data in the data frame as one or more tiles on the display device. The data overlapped by a tile is fully rendered as a HQ tile if HQ rendering of the data overlapped by the tile is available. Otherwise, the data overlapped by a tile is partially rendered as a LQ tile. The system further includes means for obtaining information metrics for each LQ tile of the data frame, where the information metrics quantify information content of the data overlapped by the LQ tile. The system further includes means for ranking the LQ tiles of the data frame based on the information metrics to determine a priority for rendering the LQ tiles into HQ tiles. The system further includes means for rendering the LQ tiles of the data frame into HQ tiles on the display device in accordance with the priority.

### BRIEF DESCRIPTION OF THE DRAWINGS

FIG. 1 shows a webpage divided into tiles for rendering by a web browser according to one embodiment of the subject matter of the present disclosure;

FIGS. 2A and 2B show a flowchart of a process for a web browser to prioritize rendering of LQ tiles of webpages into HQ tiles based on information metrics according to one embodiment of the subject matter of the present disclosure;

FIG. 3 shows a frame of the webpage of FIG. 1 containing rendering of HQ and LQ tiles of the webpage according to one embodiment of the subject matter of the present disclosure;

FIG. 4 shows gradient magnitude histograms of two LQ tiles of the webpage frame of FIG. 3 used for computation of information metrics according to one embodiment of the subject matter of the present disclosure;

FIG. 5 shows a frame of the webpage frame of FIG. 3 showing rendering of higher priority LQ tiles of the webpage frame into HQ tiles based on the information metrics according to one embodiment of the subject matter of the present disclosure; and

FIG. 6 is a is a block diagram of a computer system suitable for implementing a web browser to prioritize rendering of LQ tiles of webpages based on information metrics according to one embodiment of the subject matter of the present disclosure.

Embodiments of the present disclosure and their advantages are best understood by referring to the detailed description that follows. It should be appreciated that like reference numerals are used to identify like elements illustrated in one or more of the figures.

### DETAILED DESCRIPTION

Systems and methods are disclosed for web browsers to prioritize rendering of LQ tiles of webpages into HQ tiles based on the estimated amount of information content in the LQ tiles. Webpages or frames or webpages may be cached as HQ tiles or LQ tiles for fast rendering during scrolling. While HQ tiles are tiles that have been fully rendered previously, LQ tiles are scaled down versions of the information content overlapped by the LQ tiles. LQ tiles provide quick thumbnail sketches of the information content but need to be rendered into HQ tiles to fully display the information content. The LQ tiles may contain graphics, text, images, etc. that convey different amount of information. The amount of information of the webpage content contained in the LQ tiles is estimated using information metrics. The importance of the LQ tiles is ranked based on the information metrics. LQ tiles that have more information, and hence deemed as more important, are rendered into HQ tiles first.

Because the LQ tiles are scaled down versions of the webpage, the information metrics of the LQ tiles may be efficiently computed. The information metrics for the LQ tiles may be cached with the LQ tiles so the information metrics are not re-computed. Web browsers may employ techniques such as sub-sampling to further reduce the computational burden of the information metrics computation. The ranking of the LQ tiles for HQ rendering may be performed using the information metrics for only the LQ tiles that are onscreen or soon to be onscreen as the webpage is scrolled. As the LQ tiles are rendered into HQ tiles, the LQ tiles and their information metrics in the cache may be replaced by the HQ tiles. In addition, as new LQ tiles are scrolled onscreen or offs-screen, the web browser identifies and computes the information metrics for new LQ tiles that do not have the information metrics. The web browser reprioritizes the LQ tiles as the LQ tiles to be ranked change. By rendering LQ tiles with higher information metrics into HQ tiles first, users may fast scroll webpages with minimal degradation in the display quality or content information of the webpages.

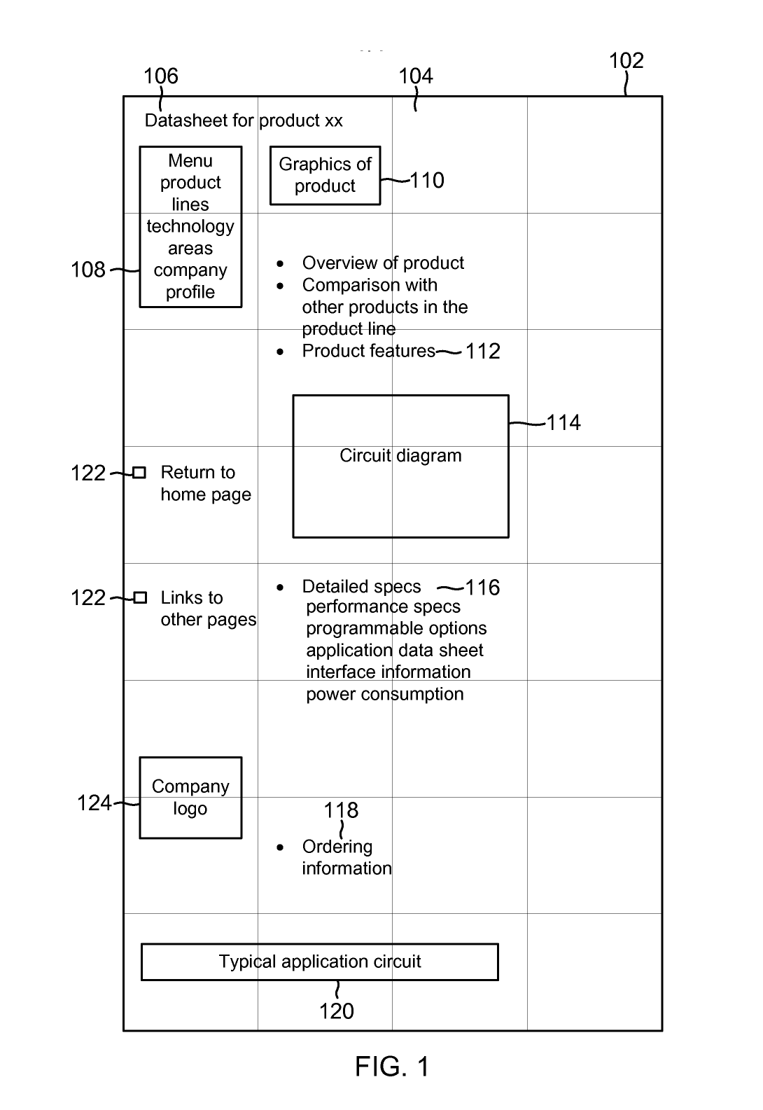

FIG. 1 shows a webpage divided into tiles for rendering by a web browser according to one embodiment of the subject matter of the present disclosure. The tiles may overlap with graphics, text, images, icons, links for videos etc. that convey different amount of information. When a web browser displays a frame of the webpage in a browser window, the web browser may retrieve the tiles from a cache and copy the tiles to the appropriate offset within the browser window. The tiles may be a mixture of HQ tiles that have been fully rendered and LQ tiles that will be rendered into HQ tiles to fully display the information in the webpage frame. As a user scrolls the webpage frame, new tiles may appear in the browser window and old tiles may disappear from the browser window. During fast scrolling, not all the LQ tiles of a frame may be rendered into HQ tiles before a new frame appears in the browser window. Thus, it is desirable to prioritize the LQ-to-HQ rendering of tiles on the basis of information metrics to more effectively convey the information content of the webpage.

The webpage used as an example in FIG. 1 may be a product datasheet webpage 102 for a product such as an electronic component found on a website of a product vendor. Product datasheet webpage 102 is divided into tiles 104 of four columns by eight rows for a total of 32 tiles. Information on product datasheet webpage 102 includes a page title 106 on the top indicating the name of the product. A menu area 108 may contain a list of pull-down menus for users to obtain information on product lines, technology areas of products in the product lines, and a company profile of the product vendor. Graphics of the product 110 may appear below page title 106 to display a perspective view of the product. A product summary section 112 may provide an overview of the product, a comparison of features with other products in the product line, and a summary of product features.

A circuit diagram 114 may display an image of the block level schematics of the product. A detailed specs section 116 may provide detailed information on performance specifications, programmable options, an application data sheet, interface information, and power consumption. A product ordering section 118 may provide information on how to order the product. A typical application circuit diagram 120 may display an image of a typical circuit in which the electronic component may be used. A navigation menu 122 may provide links for users to navigate to a home page or to other webpages. A company logo 124 may be a graphics that identifies the product vendor. Tiles 104 overlap various parts of the text, images, and graphics of product datasheet webpage 102. The amount and the type of information overlap may determine the amount of information contained in the tiles. For example, tiles 104 that overlap with circuit diagram 114 and/or detailed specs section 116 may have more information content than those that overlap with navigation menu 122 or company logo 124. Thus, the web browser may effectively convey more information by prioritizing rendering of LQ tiles into HQ tiles based on an evaluation of information metrics of the information overlapping the tiles 104 that are LQ tiles.

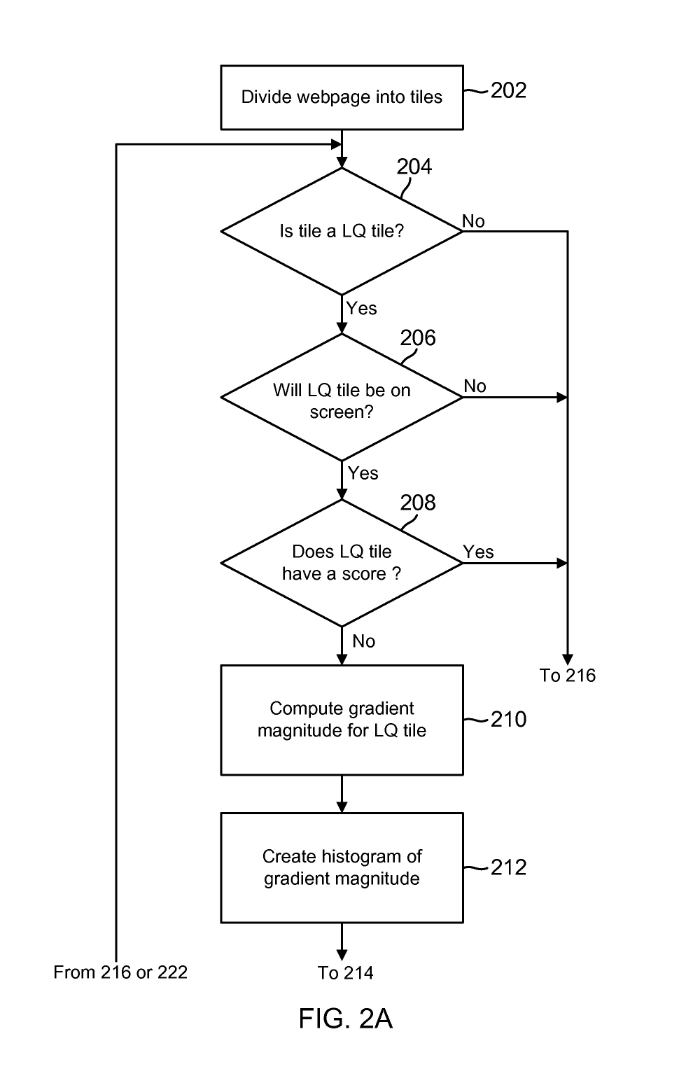

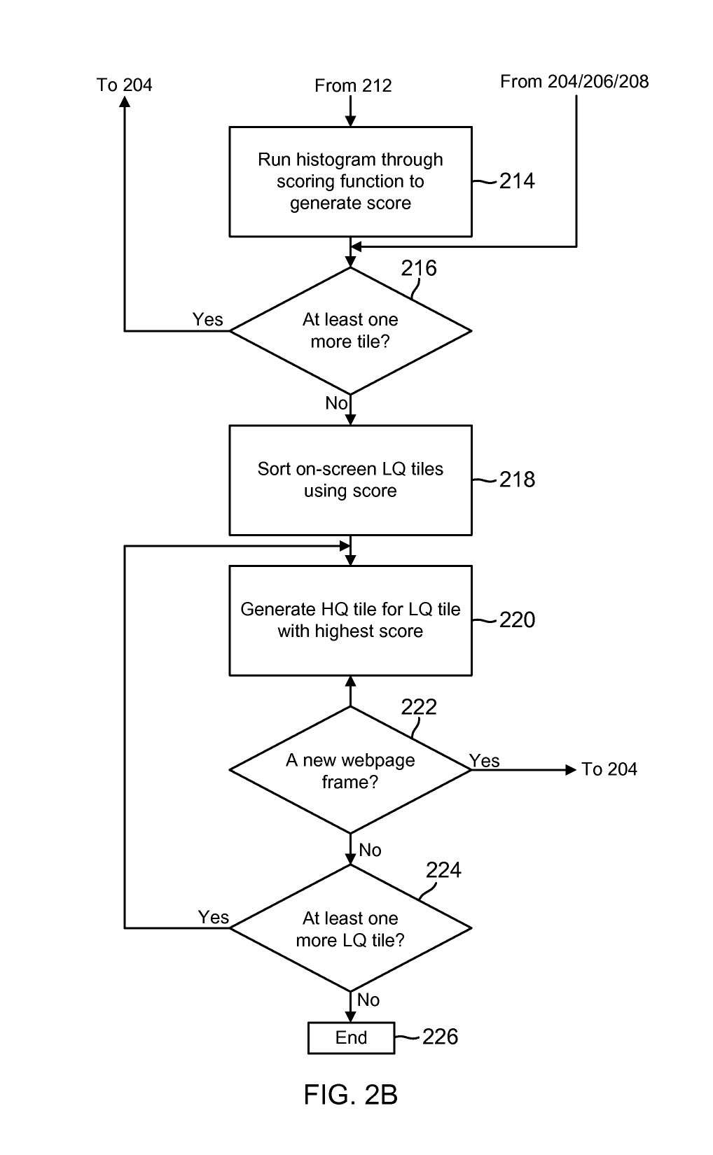

FIGS. 2A and 2B show a flowchart of a process for a web browser to prioritize rendering of LQ tiles of webpages into HQ tiles based on information metrics according to one embodiment of the subject matter of the present disclosure. In 202, the web browser divides a webpage into tiles. For example, product datasheet webpage 102 of FIG. 1 may be divided into 32 tiles. The portion of the webpage displayed in a browser window is called a webpage frame. A webpage frame may show the entire webpage if the webpage fits within a browser window or may show different portions of the webpage, and hence different tiles of the webpage, as users scroll the webpage. A webpage frame may also show only part of the tiles for tiles displayed near the edge of the browser window. In 204, the web browser determines if a tile of the webpage in the webpage frame has an associated cached LQ tile or has an associated HQ tile. If the tile has a cached HQ tile, the HQ tile has been fully rendered and may be copied from the cache to the appropriate position within the browser window. The web browser then determines if there is at least one more tile in the webpage frame in 216 that has not been examined for an associated LQ tile and may repeat 204 for the next tile. If the tile has a cached LQ tile, the LQ tile may also be copied from the cache to the appropriate position within the browser window. However, the LQ tile may need to be rendered into a HQ tile based on a priority determined from its information metrics. After a LQ tile is fully rendered into a HQ tile, the HQ tile may replace the LQ tile in the cache. If a tile is not cached at all, the tile has not been rendered previously. The web browser may render the webpage content overlapped by the tile into a LQ tile, cache the LQ tile, and copy the LQ tile to the appropriate position within the browser window. Initially, when users access a new webpage, there are no cached tiles for the webpage. Thus, all the tiles of the webpage frame may be rendered as LQ tiles.

In 206, for a LQ tile of the webpage frame, the web browser determines if the LQ tile will remain in the webpage frame due to the scrolling action of users. For example, fast scrolling of the webpage may scroll LQ tiles near the top or bottom of the webpage frame off the browser window. If the LQ tile will no longer be in the webpage frame, the LQ tile may be dropped from further consideration for rendering into a HQ tile. The web browser then determines if there is at least one more tile in the webpage frame in 216 that has not been examined for an associated LQ tile, and if there is, the web browser examines the next tile in 204 to determine if it has an associated LQ tile. The web browser may also determine if there is at least one tile that is not currently in the webpage frame but is estimated to be scrolled into the webpage frame. If there is at least a new tile to be scrolled into the webpage frame, the web browser repeats 204 to determine if the new tile has an associated LQ tile.

In 208, for a LQ tile that remains in the webpage frame or will be scrolled into the webpage frame, the web browser determines if the LQ tile has computed information metrics. The information metrics are a quantitative measure of the information content of the webpage overlapped by the LQ tiles. The information metrics may be quantified as a score. A LQ tile with a higher score is deemed to have more information content than a LQ tile with a lower score. The scores for the LQ tiles are a measure of the importance of the LQ tiles and are used to prioritize the order for rendering the LQ tiles into HQ tiles. If the LQ tile has a score, the LQ tile and its score are placed into a queue for prioritization of the order for rendering into a HQ tile. Again, the web browser determines if there is at least one more tile in the webpage frame in 216 that has not been examined for an associated LQ tile, and if there is, the web browser examines the next tile in 204 to determine if it has an associated LQ tile.

If a tile does not have a score, the web browser may compute a score for the LQ tile. For example, the web browser may compute a score using a histogram of gradient magnitudes of the information content of the LQ tile as will be described. In 210, the web browser computes gradient magnitudes for the LQ tile. The web browser may compute a gradient magnitude for each pixel of the LQ tile. In one or more embodiments, to reduce computation, the web browser may divide the pixels of the LQ tile into groups of pixels and may compute a gradient magnitude for each group of pixels, or may sub-sample the pixels to compute a gradient magnitude for every nth pixel. The gradient magnitude of a pixel or a group of pixels may be computed as a difference in magnitude between the pixel(s) with surrounding pixels. The web browser may define a region encompassing the surrounding pixels used to compute the magnitude gradient for the pixel(s). In addition, the web browser may compute a separate gradient magnitude for each color channel. The gradient magnitude of a pixel or a group of pixels is a measure of the information content of the pixel(s). Pixel(s) that are significantly different in magnitudes from the surrounding pixels are deemed to carry more information than pixel(s) that have little differences in magnitudes from the surrounding pixels.

In 212, the web browser creates a histogram of gradient magnitudes for the pixels of the LQ tile. The histogram contains information on the distribution of gradient magnitudes across a range of gradient magnitudes for all the pixels or groups of pixels in the LQ tile. For example, the x-axis of the histogram may be the range of measured gradient magnitudes and the y-axis of the histogram may be the number of pixels or groups of pixels having a specified gradient magnitude. A histogram showing a skew of the pixels toward higher gradient magnitudes indicates that the overall information content of the LQ tile is more than that of a LQ tile whose histogram shows a skew of the pixels toward lower gradient magnitudes.

In 214, the web browser applies a scoring function to the histogram of gradient magnitudes for the LQ tile to quantify the information metrics of the LQ tile into a score. The scoring function to map the histogram may be a weighing function of the gradient magnitudes in the histogram. For example, the weighing function may compute a sum of the products of magnitude gradients and the number of pixels or groups of pixels having the magnitude gradients across the range of possible magnitude gradients in the histogram. In other embodiments, the scoring function may generate a score based on the number of pixels or groups of pixels having gradient magnitudes above a threshold. After the web browser computes the score for a LQ tile, the LQ tile and its score are placed into the queue that contains the LQ tiles that will be prioritized for rendering into HQ tiles. In 216, the web browser determines if there is at least one more tile in the webpage frame that has not been examined for an associated LQ tile. If there is at least one more tile, the web browser repeats the steps as described to determine if the tile is an LQ tile, to compute the score for the LQ tile if necessary, and to place the LQ tile and its score into the queue until all LQ tiles that are in the webpage frame or will be scrolled onto the webpage frame are in the queue.

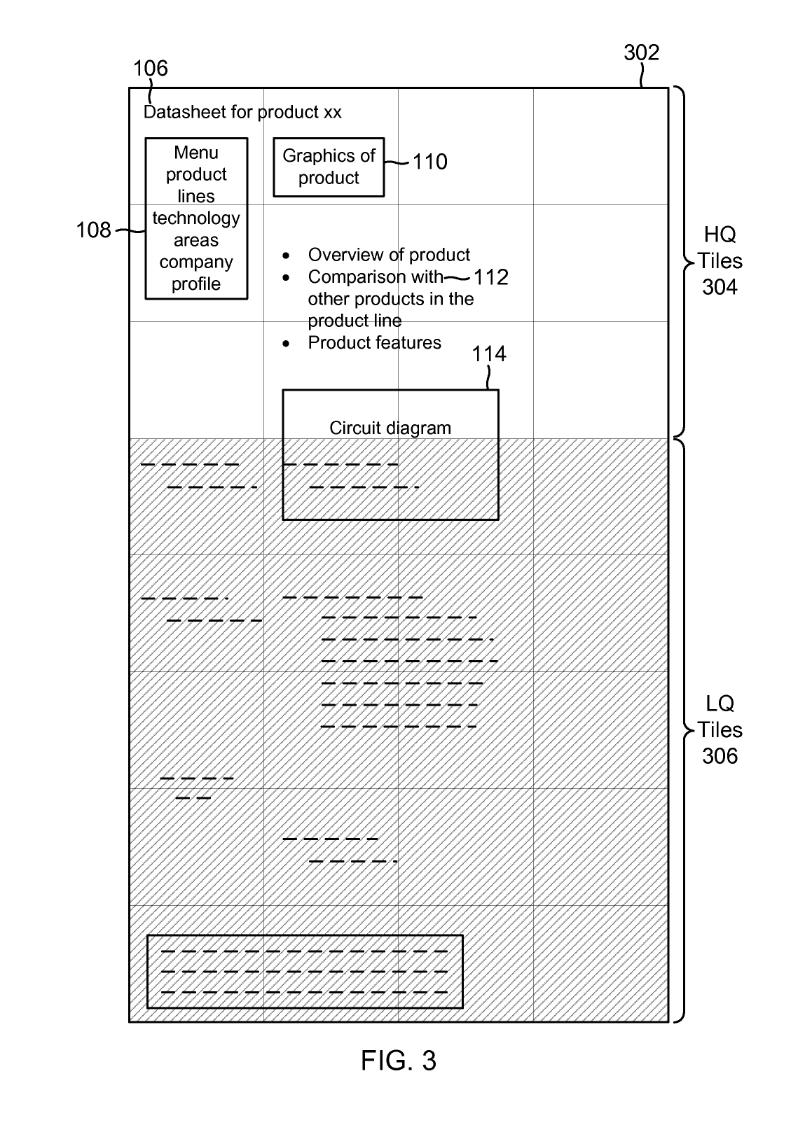

FIG. 3 shows a frame of the webpage of FIG. 1 containing rendering of HQ and LQ tiles of the webpage according to one embodiment of the subject matter of the present disclosure. A webpage frame 302 contains all the tiles of product datasheet webpage 102 with some of the tiles rendered as HQ tiles and some as LQ tiles. Webpage frame 302 contains twelve HQ tiles 304 in the top portion and twenty LQ tiles 306 in the bottom portion. HQ tiles 304 contain fully rendered versions of page title 106, menu area 108, graphics of the product 110, and product summary section 112 of product datasheet webpage 102. Circuit diagram 114 is fully rendered only for the top portion that overlaps with HQ tiles 304 and is partially rendered for the bottom portion that overlap with LQ tiles 306.

LQ tiles 306 also contain partially rendered versions of detailed specs section 116, product ordering section 118, typical application circuit diagram 120, navigation menu 122, and company logo 124 of product datasheet webpage 102. The twenty tiles of LQ tiles 306 and their scores are placed in the queue for prioritization of the order for rendering LQ tiles 306 into their HQ version. The prioritization may be based on the scores of the twenty tiles of LQ tiles 306 so that tiles that have higher scores and thus more information content are rendered into to their HQ version before tiles with lower scores.

Referring back to FIG. 2, in 218, the web browser sorts the LQ tiles in the queue based on their scores from the highest to the lowest to rank the LQ tiles. The ranking of the LQ tiles determines the order for rendering the LQ tiles into HQ tiles. LQ tiles with higher scores, and thus deemed to have more information content, are rendered into HQ tiles first. In 220, the web browser renders the LQ tile in the queue with the highest score into a HQ tile. After the LQ is rendered into the HQ tile, the HQ tile replaces the LQ tile in the webpage frame. The web browser may cache the HQ tile to replace the cached LQ tile and may remove the LQ tile with the highest score from the queue. The LQ tile with the second highest score in the queue now replaces the just removed LQ tile as the tile with the highest score in the queue. The web browser may proceed to render the new highest-score LQ tile into a HQ tile. The web browser may render the LQ tiles in accordance with their ranking until all the LQ tiles have been rendered into HQ tiles or until a new webpage frame is to be displayed in the browser window.

In 222, the web browser determines if a new webpage frame is to be displayed. A new webpage frame may be displayed when users scroll the webpage before all the LQ tiles have been rendered into HQ tiles. New tiles of the webpage may scroll into the browser window and existing tiles may scroll off the browser window. Thus, the webpage frame may contain a different set of LQ tiles whose scores will be ranked to prioritize the rendering of the LQ tiles into HQ tiles. If there is a new webpage frame, the web browser repeats 204-216 to determine if each of the new tile is a LQ tile, to compute the score for the new LQ tile if necessary, and to place the new LQ tile and its score into the queue until all new LQ tiles that are in the new webpage frame or will be scrolled onto the new webpage frame are in the queue. The web browser may keep in the queue existing LQ tiles that are still in the browser window and will remain in the new webpage frame. On the other hand, the web browser may remove from the queue LQ tiles that scroll off the browser window and thus are no longer part of the new webpage frame. The web browser re-sorts the LQ tiles in the queue in 218 to re-prioritize the order for rendering the LQ tiles into HQ tiles.

If there is no new webpage frame in 222, the web browser determines if there is at least one more LQ tile in the queue to render into a HQ tile in 224. If there is, the web browser repeats 220 to render the highest-score LQ tile in the queue into its HQ tile, and may cache the HQ tile to replace the cached LQ tile and remove the highest-score LQ tile from the queue until all the LQ tiles have been rendered into HQ tiles or until a new webpage frame is to be displayed in the browser window.

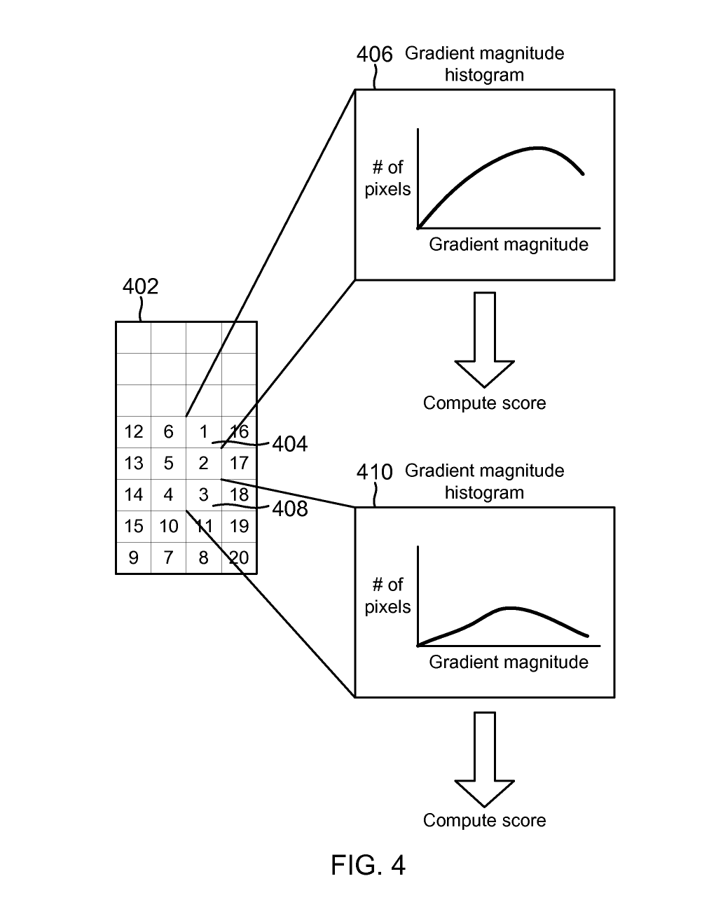

FIG. 4 shows gradient magnitude histograms of two LQ tiles of the webpage frame of FIG. 3 used for computation of information metrics according to one embodiment of the subject matter of the present disclosure. A queue 402 shows the ranking of the scores of the twenty tiles of LQ tiles 306 of webpage frame 302. The LQ tile with the highest score is a highest-ranked tile 404 that overlaps with parts of circuit diagram 114 of product datasheet webpage 102. A gradient magnitude histogram 406 of highest-ranked tile 404 shows a concentration of pixels in the higher gradient magnitude range. Such a profile of the gradient magnitudes in highest-ranked tile 404 may reflect the high information content of circuits depicted in circuit diagram 114. A scoring function maps gradient magnitude histogram 406 to a score that is the highest among the twenty tiles of LQ tiles 306. Highest-ranked tile 494 is thus the first LQ tile rendered to a HQ tile.

Queue 402 additionally shows a third-ranked tile 408 that overlaps with parts of detailed specs section 116 of product datasheet webpage 102. The parts of detailed specs section 116 that overlap with third-ranked tile 408 contain information on an application data sheet, interface information, and power consumption of the product. A gradient magnitude histogram 410 of third-ranked tile 408 shows a concentration of pixels in the middle gradient magnitude range. The information content of third-ranked tile 408 as determined from gradient magnitude histogram 410 is less than that of highest-ranked tile 494 as determined from gradient magnitude histogram 406. The scoring function maps gradient magnitude histogram 410 to a score that is the third highest score. Third-ranked tile 408 is thus the third LQ tile rendered to a HQ tile.

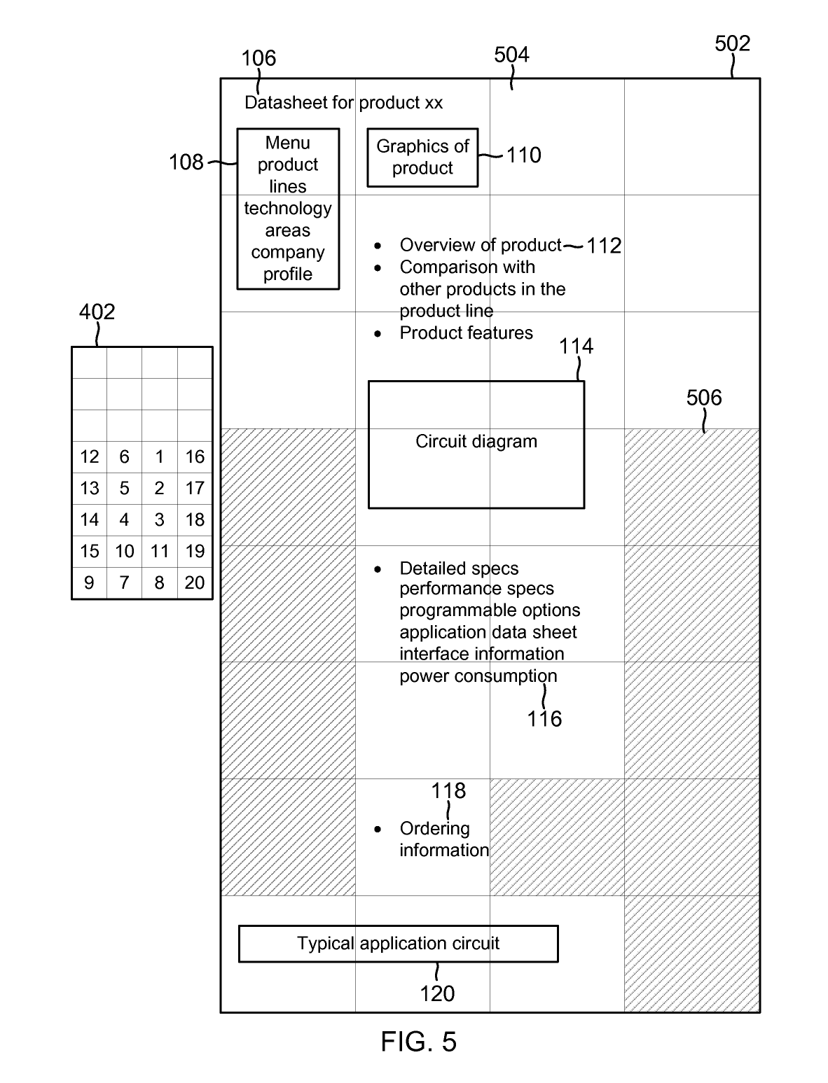

FIG. 5 shows a frame of the webpage frame of FIG. 3 showing rendering of higher priority LQ tiles of the webpage frame into HQ tiles based on the ranking of the information metrics according to one embodiment of the subject matter of the present disclosure. Queue 402 again shows the ranking of the scores of the twenty LQ tiles 306 of webpage frame 302. LQ tiles that have scores ranked from 1 to 10 have been rendered into HQ tiles. A webpage frame 502 contains twenty-two HQ tiles 504 that include the twelve HQ tiles 304 of webpage frame 302 and ten additional HQ tiles rendered from LQ tiles 306 that have the top ten scores in queue 402. The ten LQ tiles 306 that have the bottom ten scores in queue 402 remain as LQ tiles 506. Thus, webpage frame 502 contains a fully rendered version of circuit diagram 114, a fully rendered version of most of detailed specs section 116, a fully rendered version of product ordering section 118, and typical application circuit diagram 120, all rendered from the ten LQ tiles 306 with the top ten scores, in addition to the fully rendered versions of page title 106, menu area 108, graphics of the product 110, and product summary section 112. LQ tiles 506 contain partially rendered versions of navigation menu 122, and company logo 124 that have low information content. Advantageously, because most of the information content of product datasheet webpage 102 displayed in webpage frame 502 is rendered in HQ tiles, users may not notice the absence of information from LQ tiles 506.

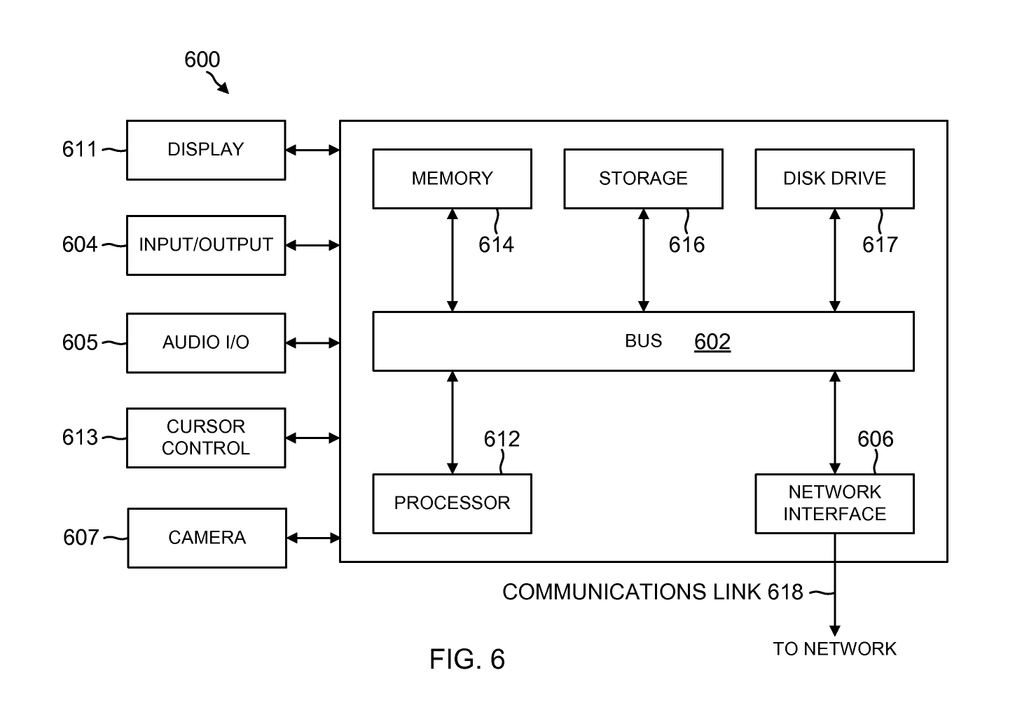

FIG. 6 is a block diagram of a computer system 600 suitable for implementing a web browser to prioritize rendering of LQ tiles of webpage frames according to one embodiment of the subject matter of the present disclosure. The web browser may comprise or implement a plurality of hardware components and/or software components that operate to perform various methodologies in accordance with the described embodiments.

Computer system 600 includes a bus 602 or other communication mechanism for communicating data, signals, and information between various components of computer system 600. Components include an input/output (I/O) component 604 that processes user action, such as detecting users scrolling webpages in the web browser, clicking on links or entering uniform resource locators (URLs) of webpages, etc., and sends a corresponding signal to bus 602. I/O component 604 may also include an output component such as a display 611 for displaying the browser window, an input component such as a camera 607, and an input control such as a cursor control 613 (such as a virtual keyboard, virtual keypad, virtual mouse, etc.). An optional audio input/output component 605 may also be included to allow a user to use voice for inputting information by converting audio signals into information signals. Audio I/O component 605 may allow the user to hear audio. A transceiver or network interface 606 transmits and receives signals between computer system 600 and other devices, such as another user device, or another network computing device via a communication link 618 to a network. In one embodiment, the transmission is wireless, although other transmission mediums and methods may also be suitable. A processor 612, which can be a micro-controller, digital signal processor (DSP), or other processing component, processes these various signals, such as for display on computer system 600 or transmission to other devices via communication link 618. Processor 612 may also control transmission of information, such as cookies or IP addresses, to other devices.

Components of computer system 600 also include a system memory component 614 (e.g., RAM), a static storage component 616 (e.g., ROM), and/or a disk drive 617. Computer system 600 performs specific operations by processor 612 and other components by executing one or more sequences of instructions contained in system memory component 614. Logic may be encoded in a computer readable medium, which may refer to any medium that participates in providing instructions to processor 612 for execution. Such a medium may take many forms, including but not limited to, non-volatile media, volatile media, and transmission media. In various implementations, non-volatile media includes optical, or magnetic disks, or solid-state drives, such as storage component 616 or disk drive 617; volatile media includes dynamic memory, such as system memory component 614; and transmission media includes coaxial cables, copper wire, and fiber optics, including wires that comprise bus 602. In one embodiment, the logic is encoded in non-transitory computer readable medium. In one example, transmission media may take the form of acoustic or light waves, such as those generated during radio wave, optical, and infrared data communications.

In various embodiments of the present disclosure, execution of instruction sequences to practice the present disclosure may be performed by computer system 600. In various other embodiments of the present disclosure, a plurality of computer systems 600 coupled by communication link 618 to the network (e.g., such as a LAN, WLAN, PTSN, and/or various other wired or wireless networks, including telecommunications, mobile, and cellular phone networks) may perform instruction sequences to practice the present disclosure in coordination with one another.

For example, instructions for the web browser to prioritize rendering of LQ tiles of webpages into HQ tiles based on information metrics of the LQ tiles may be stored in the computer readable medium of system memory component 614, storage component 616, or disk drive 617 for execution by processor 612. Processors may execute the instructions to compute gradient magnitudes for the LQ tiles, create histograms of the gradient magnitudes, apply a scoring function to the histograms of gradient magnitudes to generate scores, sort the scores for the LQ tiles to assign a priority of rendering of the LQ tiles, and render the LQ tiles to HQ tiles in accordance with the priority. Processors may also execute the instructions to manage a queue that stores the LQ tiles and their information metrics for prioritizing the order of the rendering and to update the queue when the LQ tiles in the frames of the webpages change due to user scrolling, as well as to manage cached HQ tiles and LQ tiles.

Where applicable, various embodiments provided by the present disclosure may be implemented using hardware, software, firmware, or combinations thereof. Also where applicable, the various hardware components, software components, and/or firmware components set forth herein may be combined into composite components comprising software, firmware, hardware, and/or all without departing from the spirit of the present disclosure. Where applicable, the various hardware components, software components, and/or firmware components set forth herein may be separated into sub-components comprising software, firmware, hardware, or all without departing from the spirit of the present disclosure. In addition, where applicable, it is contemplated that software components may be implemented as hardware components, and vice-versa. Where applicable, the ordering of various steps described herein may be changed, combined into composite steps, and/or separated into sub-steps to provide features described herein.

For example, computer system 600 may include hardware to compute gradient magnitudes as differences in magnitudes between pixels and their surrounding pixels in the LQ tiles and to provide the computed gradient magnitudes to processor 612 for generating the histogram and the information metrics for the LQ tiles. Computer system 600 may allocate a portion of system memory 614 as the queue that stores the LQ tiles and their information metrics. Processor 612 may manage and update the queue to prioritize the order of the rendering of the LQ tiles when the LQ tiles in the frames of the webpages change due to user scrolling. Similarly, computer system may allocate a portion of system memory 614 to cache the HQ tiles and LQ tiles for processor 612 to read and copy to the browser window when rendering frames of the webpages.

Although embodiments of the present disclosure have been described, these embodiments illustrate but do not limit the disclosure. For example, although the information metrics are computed from histograms of gradient magnitudes, embodiments of the present disclosure may encompass metrics based on other measures of information content such as the types of multimedia elements presented. It should also be understood that although the priority of rendering is shown as based on information metrics of content contained in fixed size tiles, embodiments of the present disclosure may encompass prioritizing the rendering based on other criteria set by the web browser or configured by users, in contents contained in tiles that are variable in size. It should also be understood that embodiments of the present disclosure should not be limited to these embodiments but that numerous modifications and variations may be made by one of ordinary skill in the art in accordance with the principles of the present disclosure and be included within the spirit and scope of the present disclosure as hereinafter claimed.

What is claimed is:

1. A method for displaying data on a display device, comprising:
dividing the data into a plurality of tiles;
determining a portion of the data for display in a data frame;
rendering the data in the data frame as one or more tiles on the display device, wherein the data overlapped by a tile is fully rendered as a high quality (HQ) tile if a HQ rendering of the data overlapped by the tile is available, and wherein the data overlapped by a tile is partially rendered as a low quality (LQ) tile if a HQ rendering of the data overlapped by the tile is not available;
obtaining information metrics for each LQ tile of the data frame, wherein the information metrics quantify information content of the data overlapped by the LQ tile;
ranking the LQ tiles of the data frame based on the information metrics to determine a priority for rendering the LQ tiles into HQ tiles; and
rendering the LQ tiles of the data frame into HQ tiles on the display device in accordance with the priority.

2. The method of claim 1, wherein said obtaining information metrics for each LQ tile of the data frame comprises:
determining that a LQ tile does not have the information metrics;
computing a plurality of gradient magnitudes for the data overlapped by the LQ tile;
creating a histogram of the plurality of gradient magnitudes; and
applying a scoring function to the histogram of the gradient magnitudes to generate a score for the LQ tile.

3. The method of claim 2, wherein said ranking the LQ tiles of the data frame comprises:
sorting the scores for the LQ tiles from a highest score to a lowest score; and
assigning a decreasing order of priority to the LQ tiles based on said sorting of the scores from the highest score to the lowest score.

4. The method of claim 2, wherein said computing a plurality of gradient magnitudes comprises computing differences in magnitude between a pixel and surrounding pixels for a plurality of pixels in the LQ tile.

5. The method of claim 2, wherein the scoring function comprises a sum of products of the plurality of magnitude gradients and histogram values corresponding to the plurality of magnitude gradients.

6. The method of claim 1, further comprising:
placing the LQ tiles of the data frame and the information metrics for the LQ tiles in a queue for said ranking of the LQ tiles; and
removing a LQ tile and its information metrics from the queue after said rendering of the LQ tile into a HQ tile.

7. The method of claim 6, further comprising:
determining a different portion of the data for display in a new data frame before rendering all the LQ tiles of the data frame into HQ tiles;
removing from the queue LQ tiles of the data frame that are not in the new data frame;
placing new LQ tiles of the new data frame and the information metrics of the new LQ tiles into the queue, wherein the new LQ tiles are LQ tiles of the new data frame not in the data frame; and
ranking the LQ tiles of the new data frame in the queue.

8. The method of claim 1, wherein said determining a portion of the data for display in a data frame comprises estimating the portion of the data that will be in the data frame from scrolling of the data.

9. The method of claim 1, further comprising caching the LQ tiles and the HQ tiles of the data frame for use in rendering a new data frame.

10. The method of claim 9, wherein said rendering the data in the data frame as one or more tiles on the display device comprises rendering the data overlapped by a tile as a HQ tile on the display device if the HQ tile is available as a cached HQ tile.

11. An apparatus, comprising:
a display;
a memory; and
one or more processors coupled to the memory and configured to:
divide data for display into a plurality of tiles;
determine a portion of the data for display in a data frame;
render the data in the data frame as one or more tiles on the display, wherein the data overlapped by a tile is fully rendered as a high quality (HQ) tile if a HQ rendering of the data overlapped by the tile is available, and wherein the data overlapped by a tile is partially rendered as a low quality (LQ) tile if a HQ rendering of the data overlapped by the tile is not available;
obtain information metrics for each LQ tile of the data frame, wherein the information metrics quantify information content of the data overlapped by the LQ tile;
rank the LQ tiles of the data frame based on the information metrics to determine a priority to render the LQ tiles into HQ tiles; and
render the LQ tiles of the data frame into HQ tiles on the display in accordance with the priority.

12. The apparatus of claim 11, wherein the one or more processors configured to obtain information metrics for each LQ tile of the data frame comprises the processors configured to:
determine that a LQ tile does not have the information metrics;
compute a plurality of gradient magnitudes for the data overlapped by the LQ tile;
create a histogram of the plurality of gradient magnitudes; and
apply a scoring function to the histogram of the gradient magnitudes to generate a score for the LQ tile.

13. The apparatus of claim 12, wherein the one or more processors configured to rank the LQ tiles of the data frame comprises the processors configured to:
sort the scores for the LQ tiles from a highest score to a lowest score; and
assign a decreasing order of priority to the LQ tiles that have scores from the highest score to the lowest score.

14. The apparatus of claim 12, wherein the one or more processors configured to compute a plurality of gradient magnitudes comprises the processors configured to compute differences in magnitude between a pixel and surrounding pixels for a plurality of pixels in the LQ tile.

15. The apparatus of claim 12, wherein the scoring function comprises a sum of products of the plurality of magnitude gradients and histogram values corresponding to the plurality of magnitude gradients.

16. The apparatus of claim 11, wherein the one or more processors are further configured to:
place the LQ tiles of the data frame and the information metrics for the LQ tiles in a queue for the LQ tiles to be ranked; and
remove a LQ tile and its information metrics from the queue after the LQ tile is rendered into a HQ tile.

17. The apparatus of claim 16, wherein the one or more processors are further configured to:
determine a different portion of the data for display in a new data frame before all the LQ tiles of the data frame are rendered into HQ tiles;
remove from the queue LQ tiles of the data frame that are not in the new data frame;
place new LQ tiles of the new data frame and the information metrics of the new LQ tiles into the queue, wherein the new LQ tiles are LQ tiles of the new data frame not in the data frame; and.
rank the LQ tiles of the new data frame in the queue.

18. The apparatus of claim 11, wherein the one or more processors configured to determine a portion of the data for display in a data frame comprises the processors configured to estimate the portion of the data that will be in the data frame from scrolling of the data.

19. The apparatus of claim 11, wherein the one or more processors are further configured to cache the LQ tiles and the HQ tiles of the data frame for use to render a new data frame.

20. The apparatus of claim 19, wherein the one or more processors configured to render the data in the data frame as one or more tiles on the display comprises the processors configured to render the data overlapped by a tile as a HQ tile on the display if the HQ tile is available as a cached HQ tile.

21. A non-transitory computer-readable medium comprising a plurality of machine-readable instructions which, when executed by one or more processors, are adapted to cause the one or more processors to perform a method for displaying data on a display device, comprising:
dividing the data into a plurality of tiles;
determining a portion of the data for display in a data frame;
rendering the data in the data frame as one or more tiles on the display device, wherein the data overlapped by a tile is fully rendered as a high quality (HQ) tile if a HQ rendering of the data overlapped by the tile is available, and wherein the data overlapped by a tile is partially rendered as a low quality (LQ) tile if a HQ rendering of the data overlapped by the tile is not available;
obtaining information metrics for each LQ tile of the data frame, wherein the information metrics quantify information content of the data overlapped by the LQ tile;
ranking the LQ tiles of the data frame based on the information metrics to determine a priority for rendering the LQ tiles into HQ tiles; and
rendering the LQ tiles of the data frame into HQ tiles on the display device in accordance with the priority.

22. The non-transitory computer-readable medium of claim 21, wherein said obtaining information metrics for each LQ tile of the data frame comprises:
determining that a LQ tile does not have the information metrics;
computing a plurality of gradient magnitudes for the data overlapped by the LQ tile;
creating a histogram of the plurality of gradient magnitudes; and
applying a scoring function to the histogram of the gradient magnitudes to generate a score for the LQ tile.

23. The non-transitory computer-readable medium of claim 21, wherein the method further comprises:
placing the LQ tiles of the data frame and the information metrics for the LQ tiles in a queue for said ranking of the LQ tiles; and
removing a LQ tile and its information metrics from the queue after said rendering of the LQ tile into a HQ tile.

24. The non-transitory computer-readable medium of claim 23, wherein the method further comprises:
determining a different portion of the data for display in a new data frame before rendering all the LQ tiles of the data frame into HQ tiles;
removing from the queue LQ tiles of the data frame that are not in the new data frame;
placing new LQ tiles of the new data frame and the information metrics of the new LQ tiles into the queue, wherein the new LQ tiles are LQ tiles of the new data frame not in the data frame; and
ranking the LQ tiles of the new data frame in the queue.

25. A system for displaying data on a display device, comprising:
means for dividing the data into a plurality of tiles;
means for determining a portion of the data for display in a data frame;
means for rendering the data in the data frame as one or more tiles on the display device, wherein the data overlapped by a tile is fully rendered as a high quality (HQ) tile if a HQ rendering of the data overlapped by the tile is available, and wherein the data overlapped by a tile is partially rendered as a low quality (LQ) tile if a HQ rendering of the data overlapped by the tile is not available;
means for obtaining information metrics for each LQ tile of the data frame, wherein the information metrics quantify information content of the data overlapped by the LQ tile;
means for ranking the LQ tiles of the data frame based on the information metrics to determine a priority for rendering the LQ tiles into HQ tiles; and
means for rendering the LQ tiles of the data frame into HQ tiles on the display device in accordance with the priority.

26. The system of claim 25, wherein the means for obtaining information metrics for each LQ tile of the data frame comprises:
means for determining that a LQ tile does not have the information metrics;
means for computing a plurality of gradient magnitudes for the data overlapped by the LQ tile;
means for creating a histogram of the plurality of gradient magnitudes; and
means for applying a scoring function to the histogram of the gradient magnitudes to generate a score for the LQ tile.

27. The system of claim 25, further comprising:
means for placing the LQ tiles of the data frame and the information metrics for the LQ tiles in a queue for ranking the LQ tiles; and
means for removing a LQ tile and its information metrics from the queue after the LQ tile is rendered into a HQ tile.

28. The system of claim 27, further comprising:
means for determining a different portion of the data for display in a new data frame before rendering all the LQ tiles of the data frame into HQ tiles;
means for removing from the queue LQ tiles of the data frame that are not in the new data frame;
means for placing new LQ tiles of the new data frame and the information metrics of the new LQ tiles into the queue, wherein the new LQ tiles are LQ tiles of the new data frame not in the data frame; and
means for ranking the LQ tiles of the new data frame in the queue.
